(19) United States
(12) Patent Application Publication
(10) Pub. No.: US 2012/0041667 A1
(43) Pub. Date: Feb. 16, 2012

(54) DEVICE AND METHOD FOR OPERATING AN INTERNAL COMBUSTION ENGINE, COMPUTER PROGRAM, COMPUTER PROGRAM PRODUCT

(76) Inventors: Armin Huber, Ostfildern (DE); Jens Boettcher, Schwieberdingen (DE)

(21) Appl. No.: 13/138,238

(22) PCT Filed: Dec. 17, 2009
(86) PCT No.: PCT/EP2009/067401

§ 371 Date: Oct. 11, 2011

(30) Foreign Application Priority Data
Jan. 28, 2009 (DE) 102009000444.0

(51) Int. Cl. F02D 41/30; F02D 28/00

(52) U.S. Cl. 701/104

(57) ABSTRACT

In a method for operating an internal combustion engine having a first injection valve for a first combustion chamber and a second injection valve for a second combustion chamber, the engine is operated in a first operating mode in which the fuel is injected by the first and by the second injection valve, and a first operating characteristic of the engine is determined during the first operating mode. The engine is further operated in a second operating mode in which injection of fuel by the first injection valve is suppressed, and a second operating characteristic of the engine is determined during the second operating mode. The first and second operating characteristics are compared, and, as a function of the comparison, the engine is operated in the second operating mode or in a third operating mode in which injection of fuel by the second injection valve is suppressed.

### BACKGROUND OF THE INVENTION

1. Field of the Invention

The present invention relates to selective control of injection valves of an internal combustion engine.

2. Description of Related Art

From published German patent application document DE 40 09 305, an electronic ignition control device is known in which ignition coils are used to produce ignition sparks at spark plugs in combustion chambers of an internal combustion engine.

From published German patent application document DE 39 02 254, a method is known for assigning ignition signals to a reference cylinder in which different signal levels of the main and supporting sparks, or the time shift between the beginning of the main and supporting sparks, are used for the assignment. For this purpose, frequency dividers are used that supply a signal via which the occurrence of the high-voltage pulses is inferred.

In other internal combustion engines having double-spark ignition systems, the recognition of the active cylinder takes place using a phase sensor that measures the position of the camshaft.

In low-cost internal combustion engines, double-spark ignition systems are often used, and the phase sensor is omitted in order to further reduce production costs. In such engines, the recognition of the active cylinder should take place as far as possible without the use of additional components such as the phase sensor or the frequency divider, in order to avoid additional production costs for these components.

### BRIEF SUMMARY OF THE INVENTION

In comparison to the above, the device, the method, and the computer program product according to the present invention have the advantage that a first injection valve is used to inject fuel for combustion in a first combustion chamber and a second injection valve is used to inject fuel for combustion in a second combustion chamber,
the internal combustion engine being operated in a first operating mode in which fuel is injected using the first and second injection valve,
a first operating characteristic of the internal combustion engine being determined during operation of the internal combustion engine in the first operating mode,
the internal combustion engine being operated in a second operating mode in which the injection of fuel by the first injection valve is suppressed,
a second operating characteristic of the internal combustion engine being determined during operation of the internal combustion engine in the second operating mode,
the first operating characteristic being compared to the second operating characteristic,
as a function of the result of the comparison, the internal combustion engine being operated in the second operating mode or in a third operating mode in which the injection of the fuel by the second injection valve is suppressed.

In an internal combustion engine having two cylinders situated in the same crankshaft plane, in this way in an internal combustion engine that in particular has double-spark ignition the cylinder in which a misfire has occurred is easily deactivated. Production costs are saved due to the omission of the additional components such as phase sensors or frequency dividers. If the phase sensor is provided for other reasons, the method according to the present invention can be used to operate the internal combustion engine even if the phase sensor is defective.

It is particularly advantageous if a changeover takes place from the first operating mode to the second operating mode as soon as, in the first operating mode, a plurality of misfires, in which the combustion of the fuel does not take place in the first and/or second combustion chamber, are recognized. Driver comfort is increased if the recognition is not activated until a misfire has actually been recognized in one of the two cylinders of the internal combustion engine.

It is particularly advantageous if the first and second operating characteristic is a signal that enables inference of the combustion or non-combustion of fuel in the combustion chambers. In this way, misfires can be recognized, and subsequently the combustion can be suppressed in the cylinder or cylinders in which the combustion did not take place or was incomplete.

It is particularly advantageous if the first and/or the second operating characteristic characterize a running smoothness of the internal combustion engine, a pressure in the combustion chamber, a vibration in a sealing gap between the cylinder head and the cylinder block, and/or an ion stream of an exhaust gas that results during combustion. The determination of the running smoothness by an increment sensor on a crankshaft of the internal combustion engine enables particularly simple determination of misfires using sensors already present in the internal combustion engine. If other sensors are already installed in the internal combustion engine, such as a combustion chamber pressure sensor, a knock sensor, or an ion stream sensor, the misfires are also determined particularly reliably by evaluating the signals thereof.

It is particularly advantageous if a first piston that limits the first combustion chamber and a second piston that limits the second combustion chamber are situated in the same plane of a crankshaft of the internal combustion engine.

This situation ensures robust operation of the internal combustion engine with double-spark ignition, even without a phase sensor or in case of failure of the phase sensor.

It is particularly advantageous if a first spark plug situated at the first combustion chamber and a second spark plug situated at the second combustion chamber are simultaneously ignited. The double-spark ignition is thus realized at particularly low cost for example by an individual ignition coil that simultaneously controls both spark plugs.

It is particularly advantageous if the first operating characteristic is determined while the first piston essentially outputs a torque contribution to the crankshaft, and the second operating characteristic is determined while the second piston essentially outputs a torque contribution to the crankshaft, or the first operating characteristic is determined while the second piston essentially outputs a torque contribution to the crankshaft and the second operating characteristic is determined while the first piston essentially outputs a torque contribution to the crankshaft.

In an internal combustion engine having camshaft drive and double-spark ignition, the cams of the camshaft are set in such a way that the second cylinder is in the intake stroke when the first cylinder is in the power stroke. In one working cycle of a four-stroke internal combustion engine, the crankshaft runs through an angular range of 0 to 720°.

In the process, both the first and the second cylinder each run through one power stroke and one intake stroke. However, due to the absence of the phase sensor, it is not possible to carry out a clear assignment of the strokes to particular crankshaft angles. For example, at a crankshaft angle of 0° the first cylinder may be either in the power stroke or in the intake stroke. Through the coding of a pole wheel provided for the determination of the segment times in an increment sensor, said wheel having for example 60-2 teeth, the position of the crankshaft is unambiguously assigned either to the power stroke or to the intake stroke.

If, for example, the crankshaft position of 0° is assigned to the position of the crankshaft in which 72° has already been moved through since recognition of the gap in the pole wheel, and if the first piston and the second piston are each at top dead center when this is the case, then the beginning of the power stroke or of the intake stroke is unambiguously assigned to crankshaft position 0° or 360°.

At these crankshaft angles, the first piston and the second piston are at top dead center. Here the length of the strokes is 180° of crankshaft angle. In order to determine the running smoothness of the internal combustion engine, the crankshaft angular range should be observed in which one of the two cylinders outputs a torque contribution to the crankshaft.

Thus, if the first time duration is determined in a crankshaft angular range of 0° to 180°, and the second time duration is determined in a crankshaft angular range from 360° to 540°, then the segment times for the two power strokes of the first and of the second cylinder are determined.

What is decisive for the running smoothness is the segment region in which a torque contribution is outputted to the crankshaft by the first cylinder or by the second cylinder. Thus, the segment region that is to be observed, and thus the first time duration and the second time duration, are not necessarily identical with the crankshaft angle of 0° to 180°, or 360° to 540°. Therefore, it is provided that the segments that are to be observed for the determination of the first and the second time duration are aligned with the beginning and ending of the power stroke of one of the cylinders. However, the observed angular segments can also be selected so as to differ from the beginning and ending of the power stroke, in the region in which the torque contribution of the first or of the second cylinder to the crankshaft is outputted.

It is particularly advantageous if the comparison takes place as a function of a difference or a ratio between the magnitude of the first operating characteristic and the magnitude of the second operating characteristic. In this way, the comparison is carried out particularly simply.

It is particularly advantageous if longer-term mean values, in particular averaged over more than three values, are used for the comparison. Through the use of the filter, the comparison is carried out particularly robustly.

### BRIEF DESCRIPTION OF THE DRAWINGS

FIG. 1 schematically shows an internal combustion engine.

FIG. 2 shows a flow diagram of an exemplary embodiment.

### DETAILED DESCRIPTION OF THE INVENTION

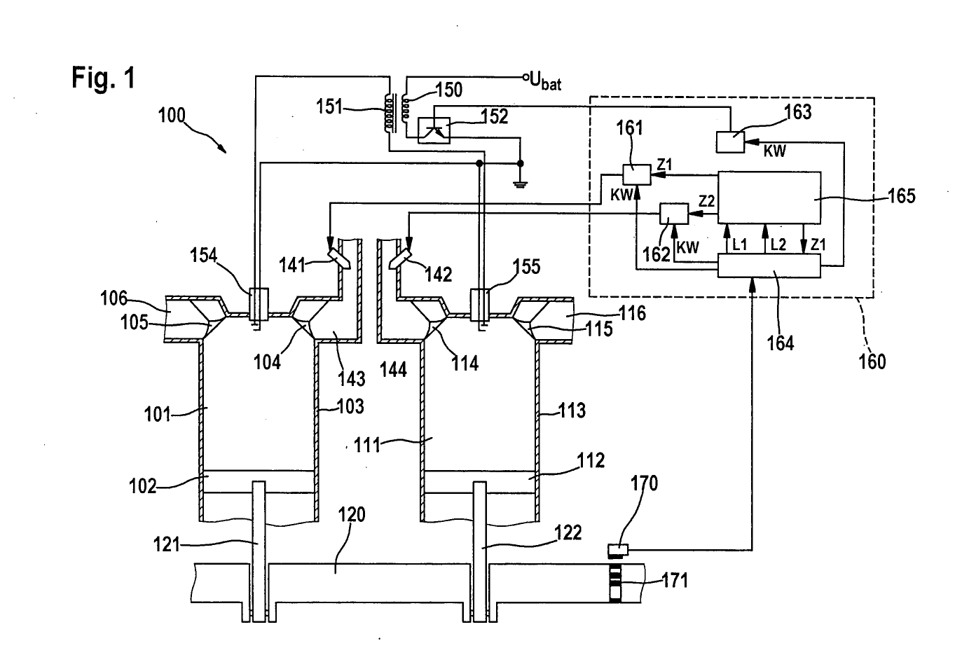

FIG. 1 shows an externally ignited internal combustion engine, for example a four-stroke spark-ignition engine having for example four cylinders and a double-spark ignition system, designated with reference character 100. For the sake of clarity, only two of the cylinders are shown in FIG. 1. The method and the device according to the present invention are not limited to spark-ignition engines having four cylinders. The invention applies analogously to internal combustion engines having two or more cylinders.

Internal combustion engine 100 has for example four cylinders, of which FIG. 1 shows a first cylinder 103 and a second cylinder 113. First cylinder 103 encloses, with first piston 102, a first combustion chamber 101. First piston 102 is connected to a crankshaft 120 via a first connecting rod 121.

Second cylinder 113 encloses, with second piston 112, a second combustion chamber 111. Second piston 112 is connected to crankshaft 120 via a second connecting rod 122.

First connecting rod 121 and second connecting rod 122 are situated in the same plane as crankshaft 120. This means that first connecting rod 121 and second connecting rod 122 are fastened to crankshaft 120 in such a way that first piston 102 and second piston 112 are simultaneously raised or lowered when crankshaft 120 rotates. Due to this synchronous movement of first piston 102 and second piston 112, the two pistons simultaneously reach top dead center and bottom dead center.

In first cylinder 103 there are situated a first intake valve 104 and a first exhaust valve 105. In second cylinder 113 there are situated a second intake valve 114 and a second exhaust valve 115. The intake and exhaust valves are connected to crankshaft 120 for example via a camshaft that is not shown in FIG. 1. In a known manner, the intake and exhaust valves are opened or closed by the camshaft synchronously with the movement of the pistons of internal combustion engine 100.

During a working cycle of first cylinder 103 and second cylinder 113, crankshaft 120 goes through two rotations, corresponding to a crankshaft angular range of 0° to 720°. The working cycle of first cylinder 103 is here made up of a first intake stroke, a first compression stroke, a first power stroke, and a first exhaust stroke. The working cycle of second cylinder 113 is made up of a second intake stroke, a second compression stroke, a second power stroke, and a second exhaust stroke. Here the valve controlling via the camshaft is constructed or set in such a way that second cylinder 113 is always in the intake stroke when first cylinder 103 is in the power stroke.

The injection of fuel by a first injection valve 141 into a first intake pipe 143 creates a first fuel-air mixture that moves into first combustion chamber 101 through intake valve 104 during the first intake stroke. This first fuel-air mixture is compressed in combustion chamber 101 in the first compression stroke, and is ignited by a first spark plug 154, for example shortly before first piston 102 reaches top dead center.

Thermal energy that results from the combustion of the first fuel-air mixture in the first power stroke is at least partly converted into mechanical energy by first piston 102, and is transmitted to crankshaft 120 by first connecting rod 121.

A first exhaust gas resulting from the combustion of the first fuel-air mixture is expelled through first exhaust valve 105 into a first exhaust pipe 106, in the first exhaust stroke.

The injection of fuel by a second injection valve 142 into a second intake pipe 144 creates a second fuel-air mixture that moves into second combustion chamber 111 through second intake valve 114 in the second intake stroke. This second fuel-air mixture is compressed in combustion chamber 111 in the second compression stroke, and is ignited by a second spark plug 155, for example shortly before second piston 112 reaches top dead center.

Thermal energy that results from the combustion of the second fuel-air mixture in the second power stroke is at least partly converted into mechanical energy by second piston 112, and is transmitted to crankshaft 120 by second connecting rod 122.

In the subsequent, second exhaust stroke, a second exhaust gas resulting from the combustion of the second fuel-air mixture is expelled through second exhaust valve 115 into a second exhaust pipe 116.

Alternatively to a camshaft controlling, the controlling of the intake and exhaust valves can also take place using a variable valve drive. The method according to the present invention is then applied in an analogous manner.

The injection of the fuel by the injection valves can, in addition or alternatively, also take place directly into the combustion chambers of the cylinders. The method according to the present invention is then applied in an analogous manner.

As fuel, for example gasoline may be used. The method according to the present invention is applied in an analogous manner if, instead of gasoline, for example compressed natural gas or some other fuel is used.

The ignition of the first fuel-air mixture and of the second fuel-air mixture takes place for example using a double-spark ignition system. A double-spark ignition system is made up for example of first spark plug 154 and second spark plug 155, which are connected to a common ignition coil. The ignition coils are for example made up of a primary coil 150 and a secondary coil 151 that are magnetically coupled. In addition, the ignition coil includes for example a first switch 152, for example a transistor. Primary coil 150 is connected at the input side to battery voltage Ubat, and is connected at the output side to switch 152. The switch is connected at the input side to primary coil 150 and is connected at the output side to ground.

An electrode of first spark plug 154 and an electrode of second spark plug 155 are also connected to ground. The second electrode of first spark plug 154 is connected to the first input of secondary coil 151. The second electrode of second spark plug 155 is connected to the second input of secondary coil 151.

If no ignition is to take place, switch 152 is closed, so that a current flows through coil 150. At the time of ignition, switch 152 is opened and the flow of current through primary coil 150 is interrupted. Through this change of the flow of current, via secondary coil 151 an ignition voltage is induced that simultaneously causes a spark formation in first spark plug 154 and in second spark plug 155.

If uncombusted first fuel-air mixture is present in compressed form in first combustion chamber 101, the ignition spark in first spark plug 154 causes the ignition of the first fuel-air mixture. Otherwise, first cylinder 103 is in the exhaust stroke, and the ignition spark in spark plug 154 has no effect with respect to an ignition. The same holds correspondingly for second cylinder 113.

The time of ignition is determined for example by a control device 160 situated in internal combustion engine 100.

Alternatively, the time of ignition can also be produced by a signal of a Hall sensor situated on crankshaft 120. Typically, the ignition time is selected such that the ignition takes place shortly before first piston 102 or second piston 112 reaches top dead center.

Control device 160 includes a first prespecification device 161, a second prespecification device 162, a third prespecification device 163, an acquisition device 164, and a calculating device 165.

Acquisition device 164 acquires the signal of an increment sensor 170 that transmits signals to acquisition device 164 using a pole wheel situated on crankshaft 120. For example, a pole wheel having 60-2 teeth is used in which the gap corresponding to two missing teeth is situated on crankshaft 120 in such a way that the gap is recognized by increment sensor 170 precisely at the point at which 72° of crankshaft angle still have to be moved through before first piston 102 and second piston 112 are at top dead center.

From the falling edges of the signal sent by increment sensor 170, acquisition device 164 determines crankshaft angle KW, for example in a known manner. For example, crankshaft angle KW is determined in the range 0° to 720° for two rotations of crankshaft 120. For example, the crankshaft angle of 0° is recognized precisely when 720° of crankshaft angle have been moved through, after the tooth gap of pole wheel 171 was recognized for the first time by increment sensor 170 when internal combustion engine 100 was started. Moreover, acquisition device 164 determines a first operating characteristic L1 and a second operating characteristic L2. For this purpose, acquisition device 164 acquires a first segment time tsₖ for the crankshaft angular range from 0° to 180°, and acquires a second segment time tsk+1 for the crankshaft angular range from 360° to 540°.

First operating characteristic L1 and second operating characteristic L2 are then for example determined as a function of first segment time tsₖ and of second segment time tsₖ₊₁, and the number z of cylinders of internal combustion engine 100 is determined for example according to the following equation:

$$L 1 , L 2 = \frac{{ts}_{k + 1} - {ts}_{k}}{{( z / 2 )}^{2} * {( \frac{{ts}_{k} + 1 + {ts}_{k}}{2} )}^{3}}$$

First operating characteristic L1 and second operating characteristic L2 characterize a smooth running operation of the internal combustion engine. Alternatively or in addition, instead of the signal of increment sensor 170, a pressure in the combustion chamber, a vibration in an air gap between the cylinder head and the cylinder block, and/or an ion stream of an exhaust gas that arises during combustion may be used to determine first operating characteristic L1 and second operating characteristic L2.

Acquisition device 164 transmits first operating characteristic L1 and second operating characteristic L2 to calculating unit 165.

Calculating unit 165 compares first operating characteristic L1 to second operating characteristic L2, for example as a function of the difference between the magnitude of first operating characteristic L1 and the magnitude of second operating characteristic L2. Alternatively, a filter, for example a lowpass filter, is used that forms longer-term mean values, in particular averaged over more than three values. These mean values are used for the comparison. For example, a starting value of the filter is selected as a function of first operating characteristic L1, and an input value of the filter is selected as a function of second operating characteristic L2. The comparison is then carried out as a function of the change in the output of the filter.

For example, for the comparison it is checked whether the difference between the magnitude of first operating characteristic L1 and the magnitude of second operating characteristic L2 is smaller than a first threshold value S1. Alternatively, it is checked whether the change in an output signal of the filter is smaller than a second threshold value S2.

If the difference between the magnitude of first operating characteristic L1 and the magnitude of second operating characteristic L2 is greater than or equal to first threshold value S1, a misfire is recognized in one of the cylinders of internal combustion engine 100. The same holds for the case in which the change in the output signal of the filter is greater than or equal to second threshold value S2.

Due to the symmetry of the piston movements of first piston 102 and second piston 112, from the signal of increment sensor 170 it is not possible to distinguish which of the two cylinders is currently in the power stroke. Therefore, it also cannot be distinguished in which of the cylinders the recognized misfire has taken place. Through the additional installation of a phase sensor for acquiring the camshaft rotational angle, it is possible to determine the position of the camshaft, and thus also the cylinder index of the cylinder currently in the power stroke. In the case in which the signal of the phase sensor is interfered with, or a phase sensor is not installed for reasons of cost, this measured information is not available. Therefore, according to the present invention, calculating device 165 changes over from a first operating mode, in which injection takes place using first injection valve 141 and second injection valve 142, to a second operating mode as soon as the misfire has been recognized.

In the second operating mode, the injection using first injection valve 141 is suppressed. For this purpose, calculating unit 165 determines a first quantity Z1_{AUS} and a second quantity Z2_{AUS}. First quantity Z1_{AUS} is set to the value 0 if the injection is to take place using first injection valve 141. First quantity Z1_{AUS} is set to the value 1 if the injection using first injection valve 141 is to be suppressed. Second quantity Z2_{AUS} is set to the value 0 if the injection is to take place using second injection valve 142. Second quantity Z2_{AUS} is set to the value 1 if the injection using second injection valve 142 is to be suppressed. In the second operating mode, therefore, first quantity Z1_{AUS} is set to the value 1 and second quantity Z2_{AUS} is set to the value 0.

In a third operating mode, first quantity Z1_{AUS} is set to the value 0 and second quantity Z2_{AUS} is set to the value 1. In this way, in the third operating mode internal combustion engine 100 is operated in such a way that the injection by second injection valve 142 is suppressed. The use of the third operating mode is further described below.

First quantity Z1 is communicated by calculating device 165 to first prespecification device 161 and to acquisition device 164. Second quantity Z2 is communicated by calculating device 165 to second prespecification device 162.

First prespecification device 161 also receives crankshaft angle KW from acquisition device 164. The first prespecification device determines a control signal for first injection valve 141 as a function of crankshaft angle KW and first quantity Z1. In a known manner, injection valve 141 is for example opened by a current signal as a function of crankshaft angle KW, for example when the crankshaft angle is 0°. If first quantity Z1 has the value 1, the controlling of first injection valve 141 is suppressed.

Second prespecification device 162 also reads crankshaft angle KW from acquisition device 164. The determination of the control signal for second injection valve 142 takes place in second prespecification device 162 in a manner analogous to the determination of the control signal for first injection valve 141. For example, in a known manner second injection valve 142 is opened whenever the crankshaft angle is 0°. If second quantity Z2 has the value 1, the controlling of second injection valve 142 is suppressed.

Through the injection at a crankshaft angle 0°, in both intake pipes there arises a fuel-air mixture that moves into the combustion chamber of the respective cylinder as soon as the respective intake valve is opened. This system ensures that the fuel-air mixture is ready to be provided for each cylinder when the respective intake valve is opened. The injection can also take place at a crankshaft angle differing from 0°.

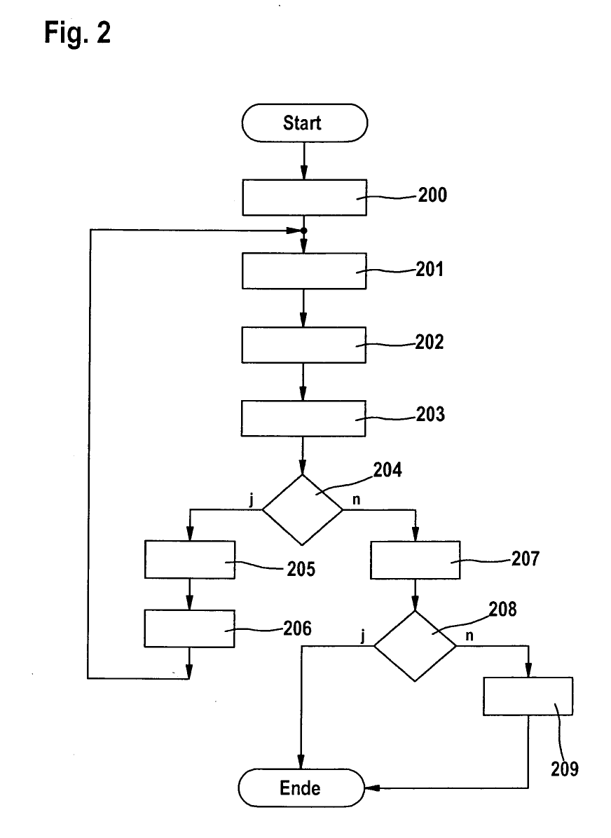

The changeover of the operating modes and the determination of first operating characteristic L1 and of second operating characteristic L2 take place for example according to the flow diagram of an exemplary embodiment shown in FIG. 2.

The method according to the present invention is for example started whenever a combustion misfire has been recognized. The recognition of the misfire can take place for example using the described comparison of first operating characteristic L1 with second operating characteristic L2, or, alternatively, using a misfire recognition device that, in modern internal combustion engines, monitors in a known manner whether a misfire has occurred. Subsequently, the method is continued in a step 200.

In step 200, first quantity Z1 and second quantity Z2 are initialized with the value 0. Subsequently, a step 201 is executed.

In step 201, first segment time tsₖ for crankshaft angular range 0° to 180° is determined. As a function of the time at which first piston 102 or second piston 112 outputs its torque contribution to crankshaft 120, it can be provided that first segment time tsₖ is determined for a different crankshaft range, which for example coincides precisely with the crankshaft angular range in which the torque contribution takes place. A step 202 is subsequently executed.

In step 202, second segment time tsₖ₊₁ is determined in the crankshaft angular range from 360° to 540°. Alternatively, the second segment time tsₖ₊₁ is determined in the crankshaft angular range in which the torque contribution to crankshaft 120 actually takes place. A step 203 is subsequently executed.

In step 203, a first auxiliary quantity luts is determined as a function of first segment time tsₖ, second segment time tsₖ₊₁, and the number z of cylinders of the internal combustion engine, for example using the following equation:

$$luts = \frac{{ts}_{k + 1} - {ts}_{k}}{{( z / 2 )}^{2} * {( \frac{{ts}_{k} + 1 + {ts}_{k}}{2} )}^{3}}$$

Subsequently, a step 204 is executed.

In step 204, it is checked whether first quantity Z1 has the value 0. If first quantity Z1 has the value 0, a step 205 is executed; otherwise, a step 207 is executed.

In step 205, first quantity Z1 is set to the value 1, and the injection using first cylinder 103 is thereby suppressed. A step 206 is subsequently executed.

In step 206, first operating characteristic L1 is set to the value of first auxiliary quantity luts. Step 201 is subsequently executed.

In step 207, second operating characteristic L2 is set to the value of first auxiliary quantity luts. A step 208 is subsequently executed.

In step 208, first operating characteristic L1 is compared to second operating characteristic L2. For example, for this purpose it is checked whether the difference in magnitude between first operating characteristic L1 and second operating characteristic L2 is smaller than a first threshold value S1. If this is the case, the method according to the present invention terminates; otherwise, a step 209 is executed.

In step 209, first quantity Z1 is set to the value 0 and second quantity Z2 is set to the value 1. This causes internal combustion engine 100 to change over to the third operating mode, in which the injection using second injection valve 142 is suppressed. The method according to the present invention subsequently terminates.

The described method ensures that precisely that cylinder is shut off in which the misfire has taken place. This makes it possible to create the assignment in the absence of a phase sensor or in the presence of a defective phase sensor.

1-12. (canceled)

13. A method for operating an internal combustion engine having a first fuel injection valve for injecting fuel into a first combustion chamber and a second fuel injection valve for injecting fuel into a second combustion chamber, comprising:
operating the internal combustion engine in a first operating mode in which fuel is injected by the first and second injection valves into the first and second combustion chambers, respectively;
determining a first operating characteristic of the internal combustion engine during operation of the internal combustion engine in the first operating mode;
operating the internal combustion engine in a second operating mode in which injection of fuel by the first injection valve is suppressed;
determining a second operating characteristic of the internal combustion engine during operation of the internal combustion engine in the second operating mode;
comparing the first operating characteristic with the second operating characteristic; and
as a function of the result of the comparison, operating the internal combustion engine in one of the second operating mode or a third operating mode in which injection of fuel by the second injection valve is suppressed;
wherein the first operating characteristic and the second operating characteristic characterize an absence of smooth running of the internal combustion engine.

14. The method as recited in claim 13, wherein a changeover takes place from the first operating mode to the second operating mode as soon as a plurality of misfires, in which combustion of fuel in at least one of the first and second combustion chambers does not take place, is recognized in the first operating mode.

15. The method as recited in claim 13, wherein the first and second operating characteristics provide information which enables determination of one of combustion or non-combustion of fuel in at least one of the first and second combustion chambers.

16. The method as recited in claim 13, wherein at least one of the first and second operating characteristics characterizes at least one of a pressure in the combustion chamber, a vibration in a sealing gap between a cylinder head and a cylinder block, and an ion stream of an exhaust gas generated during combustion.

17. The method as recited in claim 13, wherein a first piston, which limits the first combustion chamber, and a second piston, which limits the second combustion chamber, are situated in the same plane of a crankshaft of the internal combustion engine.

18. The method as recited in claim 13, wherein a first spark plug situated at the first combustion chamber and a second spark plug situated at the second combustion chamber are ignited simultaneously.

19. The method as recited in claim 17, wherein one of:
i) the first operating characteristic is determined while the first piston outputs a torque contribution to the crankshaft, and the second operating characteristic is determined while the second piston outputs a torque contribution to the crankshaft; or
ii) the first operating characteristic is determined while the second piston outputs a torque contribution to the crankshaft, and the second operating characteristic is determined while the first piston outputs a torque contribution to the crankshaft.

20. The method as recited in claim 13, wherein the comparison takes place as a function of one of a difference or a ratio between the magnitude of the first operating characteristic and the magnitude of the second operating characteristic.

21. The method as recited in claim 20, wherein each of the magnitudes of the first and second operating characteristics are averaged values obtained from at least three separate values.

22. A control device for operating an internal combustion engine in which fuel is injected by a first injection valve for combustion in a first combustion chamber and fuel is injected by a second injection valve for combustion in a second combustion chamber, comprising:
a calculating device configured to specify i) a first operating mode in which fuel is injected by the first injection valve and by the second injection valve, and ii) a second operating mode in which injection of fuel by the first injection valve is suppressed;
an acquisition device configured to determine i) a first operating characteristic of the internal combustion engine during operation of the internal combustion engine in the first operating mode, and ii) a second operating characteristic of the internal combustion engine during operation of the internal combustion engine in the second operating mode, wherein the first operating characteristic and the second operating characteristic characterize a lack of smooth running of the internal combustion engine;
a comparison device configured to compare the first operating characteristic with the second operating characteristic; and
a prespecification device configured to specify, as a function of the result of the comparison, one of the second operating mode or a third operating mode in which fuel is injected using only the first injection valve.

23. A non-transitory computer-readable data storage medium storing a computer program having program codes which, when executed on a computer, performs a method for operating an internal combustion engine having a first fuel injection valve associated with a first combustion chamber and a second fuel injection valve associated with a second combustion chamber, the method comprising:
operating the internal combustion engine in a first operating mode in which fuel is injected by the first and second injection valves into the first and second combustion chambers, respectively;
determining a first operating characteristic of the internal combustion engine during operation of the internal combustion engine in the first operating mode;
operating the internal combustion engine in a second operating mode in which injection of fuel by the first injection valve is suppressed;
determining a second operating characteristic of the internal combustion engine during operation of the internal combustion engine in the second operating mode;
comparing the first operating characteristic with the second operating characteristic; and
as a function of the result of the comparison, operating the internal combustion engine in one of the second operating mode or a third operating mode in which injection of fuel by the second injection valve is suppressed;
wherein the first operating characteristic and the second operating characteristic characterize an absence of smooth running of the internal combustion engine.
